(19) United States
(12) Patent Application Publication
(10) Pub. No.: US 2020/0379375 A1
(43) Pub. Date: Dec. 3, 2020

(54) INTERMEDIATE TRANSFER BELT, IMAGE FORMING APPARATUS INCLUDING THE SAME, AND IMAGE FORMING METHOD USING THE SAME

(71) Applicant: Konica Minolta, Inc., Tokyo (JP)

(72) Inventors: Ito KOGA, Tokyo (JP); Sadaaki SAKAMOTO, Tokyo (JP); Shiori TSUGAWA, Tokyo (JP); Daisuke IKEDA, Tokyo (JP)

(21) Appl. No.: 16/854,636

(22) Filed: Apr. 21, 2020

(30) Foreign Application Priority Data
May 28, 2019 (JP) 2019-099310

(51) Int. Cl. G03G 15/16; C08K 3/22; C09C 1/36; C09C 1/04; B32B 27/28

(52) U.S. Cl. CPC G03G 15/162; G03G 15/161; G03G 15/1615; B32B 27/281; C09C 1/3661; C09C 1/043; C08K 3/22

(57) ABSTRACT

The present invention provides a means capable of achieving both excellent image transferability and thin paper separating property in an intermediate transfer belt. An embodiment of the present invention relates to an intermediate transfer belt including a substrate, in which the substrate contains at least one resin selected from the group consisting of polyimide, polyimide-imide, and polyetherimide and highly dielectric inorganic particles subjected to at least one surface treatment selected from the group consisting of a surface treatment with an oxide of at least one metal selected from the group consisting of aluminum, zinc, tin, lead, silicon, zirconium, and titanium and a surface treatment with a coupling agent.

### CROSS-REFERENCE TO RELATED APPLICATION

This application is based upon and claims the benefit of priority of the prior Japanese Patent Application No. 2019-099310 filed on May 28, 2019, the entire contents of which are incorporated herein by reference.

### BACKGROUND

### 1. Technical Field

The present invention relates to an intermediate transfer belt, an image forming apparatus including the same, and an image forming method using the same.

### 2. Description of Related Arts

Electrophotographic image forming apparatuses generally form an image on a recording medium by forming an electrostatic latent image on a photoconductor, transferring a toner image corresponding to the electrostatic latent image to a recording medium such as plain paper, and fixing the toner image to the recording medium. As such image forming apparatuses, apparatuses including an intermediate transfer belt are known. As an example of such image forming apparatuses, an apparatus is mentioned in which a toner image is transferred from a photoconductor to an intermediate transfer belt and then from the intermediate transfer belt to a recording medium such as paper. In electrophotographic image forming apparatuses, transfer of a toner image from a photoconductor to an intermediate transfer belt and from the intermediate transfer belt to a recording medium is performed by forming a proper electric field for promoting toner movement. Hence, the electrical properties of the intermediate transfer belt (hereinafter, simply referred to as a transfer belt or a belt in some cases) are important from the viewpoint of securing the quality of final image.

In particular, as means for improving the transferability of toner image, it is mentioned to increase the relative dielectric constant of the intermediate transfer belt. This is because the voltage to be applied to the intermediate transfer belt decreases by increasing the relative dielectric constant of the intermediate transfer belt, and a voltage (electric field) is applied to the toner to that extent. This makes it possible to improve the movability of toner and the transferability of toner image. Moreover, highly dielectric materials have been conventionally added to the intermediate transfer belt in order to improve the relative dielectric constant of intermediate transfer belt. In particular, it is general to add a dielectric filler.

JP H08-152759 A discloses an image forming apparatus equipped with an intermediate transfer member, in which the intermediate transfer member contains a powder which is a dielectric powder having a relative dielectric constant of 5 or more, a specific composite oxide powder, a titanium oxide powder, or a polyvinylidene fluoride resin powder and has an average particle size of 0.1 to 100 μm. Moreover, this document discloses that the transfer efficiency can be increased and the uniformity and homogeneity of image can be improved by the intermediate transfer member having such a configuration.

JP H08-176319 A discloses a toner transfer member formed of a single-layer cylindrical polyimide film in which a dielectric inorganic powder having a dielectric constant of 100 or more is mainly dispersed in polyimide at the outer surface portion and conductive black is mainly dispersed in polyimide at the non-outer surface portion, and the like. Moreover, this document discloses that the transferability can be ameliorated and the image quality of transferred color image can be improved by the toner transfer member having such a configuration.

### SUMMARY

In recent years, there has been an increasing demand for expansion of supported media, and the range of paper thickness in which paper can pass through an apparatus has also been expanded in association with this. Moreover, in the technology to improve the transfer rate by increasing the dielectric constant as disclosed in JP H08-152759 A and JP H08-176319 A, the effect of improving the transfer rate cannot be said to be always sufficient and there is also a new problem that the thin paper cannot be separated by static electricity.

Accordingly, an object of the present invention is to provide a means capable of achieving both excellent image transferability and thin paper separating property in an intermediate transfer belt.

An embodiment of the present invention, which is one means for solving at least one of the above-described objects, has the following configuration.

An intermediate transfer belt including a substrate, in which

the substrate contains at least one resin selected from the group consisting of polyimide, polyamide-imide, and polyetherimide, and

highly dielectric inorganic particles that are subjected to at least one surface treatment selected from the group consisting of a surface treatment with an oxide of at least one metal selected from the group consisting of aluminum, zinc, tin, lead, silicon, zirconium, and titanium and a surface treatment with a coupling agent.

### BRIEF DESCRIPTION OF THE DRAWINGS

The advantages and features to be provided by one or more embodiments of the present invention are merely illustrative of each embodiment, do not limit the scope of the invention, and will be more fully understood from the detailed description given below and the accompanying drawings.

FIG. 1 is an explanatory sectional view illustrating an example of the configuration of an image forming apparatus including an intermediate transfer belt.

### DETAILED DESCRIPTION OF EMBODIMENTS

Hereinafter, one or more embodiments of the present invention will be described with reference to the drawings if necessary. However, the scope of the present invention is not limited to the disclosed embodiments.

Hereinafter, preferred embodiments of the present invention will be described. In the present specification, “X to Y” indicating a range means “X or more and Y or less”. In addition, operations, measurements of physical properties, and the like are performed under the conditions of room temperature (20° C. to 25° C.)/relative humidity of 40% to 50% RH unless otherwise stated.

Moreover, “(meth)acrylate” is the generic term for an acrylate and a methacrylate. Similarly, a compound having (meth) such as (meth)acrylic acid, and the like are the generic terms for compounds having “meth” in the name and compounds not having “meth” in the name.

Moreover, in the description of the drawings, the same elements will be denoted by the same reference symbols and duplicate description will be avoided. In addition, the dimensional ratios in the drawings are exaggerated for convenience of description and are different from the actual ratios in some cases.

<Intermediate Transfer Belt and Manufacturing Method Thereof>

An embodiment of the present invention relates to an intermediate transfer belt including a substrate, in which the substrate contains at least one resin selected from the group consisting of polyimide, polyamide-imide, and polyetherimide and highly dielectric inorganic particles which are subjected to at least one surface treatment (hereinafter, also simply referred to as “surface-treated highly dielectric inorganic particles) selected from the group consisting of a surface treatment with an oxide of at least one metal selected from the group consisting of aluminum, zinc, tin, lead, silicon, zirconium, and titanium (hereinafter, also simply referred to as “metal oxide surface treatment”) and a surface treatment with a coupling agent (hereinafter, also simply referred to as “coupling agent surface treatment”). According to an embodiment of the present invention, it is possible to provide a means capable of achieving both excellent image transferability and thin paper separating property in an intermediate transfer belt.

The present inventors presume that the mechanism through which the problem is solved by the configuration described above is as follows.

As in the technology described in JP H08-152759 A and the technology described in JP H08-176319 A, the existing distribution of the particles is likely to be ununiform depending on the affinity between the particles and the matrix material constituting the intermediate transfer belt and the aggregability of the particles in a method in which the dielectric constant of an intermediate transfer belt is increased by adding highly dielectric inorganic particles to the intermediate transfer belt. Moreover, this ununiformity of the existing distribution appears as ununiformity of capacitance on the intermediate transfer belt surface in terms of properties of the intermediate transfer belt. At this time, a portion having a large electrostatic attraction exists on the intermediate transfer belt surface, and the thin paper separating property is insufficient by the influence of the portion.

In addition, the highly dielectric inorganic particles dispersed in the matrix material constituting the substrate exist in a state in which a series state and a parallel state are mixed and dispersed when the highly dielectric inorganic particles are considered as a capacitor. Here, when the number of particles is the same, in the comparison between a case in which the existing distribution is uniform and a case in which the existing distribution is ununiform, a combined capacitance is the sum of individual capacitances and thus these combined capacitances are the same when a series state is considered. However, when a parallel state is considered, the reciprocal of a combined capacitance is the sum of the reciprocals of individual capacitances and thus these combined capacitances are smaller as the degree of ununiformity is greater. Consequently, as in the technology described in JP H08-152759 A and the technology described in JP H08-176319 A, there is a case in which the original function of the highly dielectric inorganic particles is not exerted, the capacitance as the entire belt also decreases, and the transfer rate is not sufficiently improved in a method in which the dielectric constant of intermediate transfer belt is increased by adding highly dielectric inorganic particles to the intermediate transfer belt.

On the other hand, in the present invention, at least one resin selected from the group consisting of polyimide, polyamide-imide, and polyetherimide is selected as a matrix material constituting the substrate, and highly dielectric inorganic particles subjected to a surface treatment with the specific metal oxide or a coupling agent are dispersed in this matrix material. Here, the highly dielectric inorganic particles maintain a high dielectric constant and exhibits improved affinity for the resin and improved dispersibility in the matrix material by being subjected to a surface treatment with the specific metal oxide. This makes the distribution of highly dielectric inorganic particles more uniform. In addition, the highly dielectric inorganic particles maintain a high dielectric constant, hardly cause aggregation of the highly dielectric inorganic particles, and exhibits improved dispersibility in the matrix material by being subjected to a surface treatment with a coupling agent. This makes the distribution of highly dielectric inorganic particles more uniform. As a result, in the intermediate transfer belt according to an embodiment of the present invention, the generation of a portion having a large electrostatic attraction is suppressed and the thin paper separating property is further improved. In addition, the capacitance on the belt surface is further uniformized, the original function of highly dielectric inorganic particles is exerted, the capacitance as the entire belt increases, and the transfer rate is further improved.

Incidentally, the mechanism is based on presumption and the correct or incorrect thereof does not affect the technical scope of the present invention.

Hereinafter, the respective constituents of the intermediate transfer belt according to an embodiment of the present invention will be described in detail. However, the present invention is not limited to these.

### [Substrate]

(Film Thickness)

The substrate included in the intermediate transfer belt according to an embodiment of the present invention may have a single-layer structure or a multi-layer structure composed of two or more layers. The shape of the substrate is preferably an endless belt shape. The thickness of the substrate is not particularly limited but is preferably 50 to 250 μm, more preferably 50 to 150 μm, and still more preferably 60 to 100 μm from the viewpoint of mechanical strength, image quality, manufacturing cost, and the like.

(Resin)

The substrate included in the intermediate transfer belt according to an embodiment of the present invention contains at least one resin selected from the group consisting of polyimide, polyimide-imide, and polyetherimide. These resins act to improve the transferability and thin paper separating property of the intermediate transfer belt while imparting self-supporting property to the substrate.

Among these, polyimide and polyimide-imide are preferable and polyimide is more preferable from the viewpoint of further improving the transferability and the thin paper separating property.

The weight average molecular weight of these resins is not particularly limited but is preferably 1,000 or more. In addition, the weight average molecular weight of these resins is not particularly limited but is preferably 2,000,000 or less. The weight average molecular weight can be determined as a value in terms of polystyrene to be measured by gel permeation chromatography (GPC).

As these resins, a synthetic product may be used or a commercially available product may be used. Examples of commercially available products include UPIA (registered trademark)—AT1001, ST1001, ST1002, NF1001, NF2001, FN1001, FN2001, LB1001, LB2001 and the like manufactured by UBE INDUSTRIES, LTD., for example, as a precursor (polyimide precursor) for synthesizing polyimide, but the commercially available products are not limited to these.

These resins can be used singly or in combination of two or more kinds thereof.

The lower limit of the content of resin in the substrate is not particularly limited but is preferably 1% by mass or more, more preferably 10% by mass or more, and still more preferably 30% by mass or more with respect to the total mass of the substrate from the viewpoint of further improving the transferability and thin paper separating property. In addition, the upper limit of the content of resin in the substrate is not particularly limited but is preferably 99% by mass or less, more preferably 70% by mass or less, and still more preferably 50% by mass or less with respect to the total mass of the substrate from the viewpoint of further improving the transferability.

(Surface-Treated Highly Dielectric Inorganic Particles)

The substrate included in the intermediate transfer belt according to an embodiment of the present invention contains highly dielectric inorganic particles subjected to at least one surface treatment (surface-treated highly dielectric inorganic particles) selected from the group consisting of a surface treatment with an oxide of at least one metal selected from the group consisting of aluminum, zinc, tin, lead, silicon, zirconium, and titanium (metal oxide surface treatment) and a surface treatment with a coupling agent (coupling agent surface treatment). In other words, the substrate included in the intermediate transfer belt according to the embodiment contains highly dielectric inorganic particles subjected to at least one surface treatment selected from the group consisting of a surface treatment with aluminum oxide, a surface treatment with zinc oxide, a surface treatment with tin oxide, a surface treatment with lead oxide, a surface treatment with silicon oxide, a surface treatment with zirconium oxide, a surface treatment with titanium oxide, a surface treatment with oxides of two or more metals selected from the group consisting of aluminum, zinc, tin, lead, silicon, zirconium, and titanium, and a surface treatment with a coupling agent. The surface-treated highly dielectric inorganic particles act to improve the transferability and thin paper separating property of the intermediate transfer belt.

In the present specification, the highly dielectric inorganic particles in a state of not been subjected to a surface treatment (hereinafter, also referred to as untreated highly dielectric inorganic particles) refer to inorganic particles having a relative dielectric constant εᵣ of 100 or more. In other words, the highly dielectric inorganic particles to be subjected to at least one surface treatment have a relative dielectric constant εᵣ of 100 or more. When the relative dielectric constant εᵣ of the highly dielectric inorganic particles before being subjected to a surface treatment is less than 100, the transferability is insufficient. The reason for this is presumed to be because the relative dielectric constant εᵣ as the entire belt cannot be sufficiently improved even if such particles are dispersed. The lower limit of the relative dielectric constant εᵣ of the untreated highly dielectric inorganic particles is preferably 100 or more, more preferably 500 or more, and still more preferably 1,000 or more from the viewpoint of improving the transferability of the intermediate transfer belt. In addition. the upper limit of the relative dielectric constant εᵣ of the untreated highly dielectric inorganic particles is preferably 10,000 or less, more preferably 5,000 or less, and still more preferably 2,000 or less from the viewpoint of further improving the thin paper separating property. Incidentally, in the case of using two or more kinds of untreated highly dielectric inorganic particles, the average value of relative dielectric constants εᵣ with respect to the mass ratio of the two or more kinds of untreated highly dielectric inorganic particles is preferably within the above ranges.

The relative dielectric constant εᵣ of the untreated highly dielectric inorganic particles can be measured using an LCR meter and a material pelletized to a size of 30 mm in diameter and 5 mm in thickness using a high-pressure molding machine or the like. As the LCR meter, for example, E4990A Impedance Analyzer (manufactured by Keysight Technologies Inc.) can be used.

Incidentally, the relative dielectric constant εᵣ of the untreated highly dielectric inorganic particles in the state of an intermediate transfer belt can be determined by taking out the surface-treated highly dielectric inorganic particles from the intermediate transfer belt, then removing the surface treatment layer, taking out only the untreated highly dielectric inorganic particles, and performing the above-described measurement. In addition, the relative dielectric constant εᵣ of the untreated highly dielectric inorganic particles in this state can also be determined by identifying the kind of untreated highly dielectric inorganic particles through the analysis of the intermediate transfer belt, then preparing similar untreated highly dielectric inorganic particles, and performing the above-described measurement.

The untreated highly dielectric inorganic particles are not particularly limited as long as they are inorganic particles having a relative dielectric constant εᵣ of 100 or more, but examples thereof include barium titanate (BaTiO₃), strontium titanate (SrTiO₃), calcium titanate (CaTiO₃), lead titanate (PbTiO₃), lead zirconate titanate (PZT:Pb(Zr,T)O₃), tantalum oxide (Ta₂O₃), barium strontium titanate (BST:(BaₓS₁₋ₓ)TiO₃), lead lanthanum zirconate titanate (PLZT:(Pb,La)(Zr,T)O₃: lead zirconate titanate to which La (lanthanum) is added) and the like. Among these, barium titanate or strontium titanate are preferable and barium titanate is more preferable from the viewpoint of having a sufficiently high dielectric constant, of being able to more favorably perform a surface treatment, and as a result, of further improving the transferability and thin paper separating property of the intermediate transfer belt.

The shape of the untreated highly dielectric inorganic particles is not particularly limited and may be a spherical shape or a shape close thereto or may be a plate shape, a rod shape, or a needle shape.

The lower limit of the average primary particle size (number average particle size) of the untreated highly dielectric inorganic particles is not particularly limited but is preferably 1 nm or more, more preferably 10 nm or more, and still more preferably 50 nm or more from the viewpoint of further improving the transferability and thin paper separating property of the belt. It is considered that a surface treatment can be more favorably performed when the lower limit is in this range. In addition, the upper limit of the average primary particle size (number average particle size) of the untreated highly dielectric inorganic particles is not particularly limited but is preferably 1,000 nm or less, more preferably 500 nm or less, and still more preferably 200 nm or less from the viewpoint of further improving the transferability and thin paper separating property of the belt. It is considered that the existing state of the surface-treated highly dielectric inorganic particles is further uniformized when the upper limit is in this range. The average primary particle size of the untreated highly dielectric inorganic particles can be determined by observing the particles under a scanning electron microscope (SEM), measuring the particle diameters of 100 particles in the SEM image, and calculating the average value thereof. Incidentally, in a case in which the particles exhibit anisotropy, that is, the particles have a maximum diameter and a minimum diameter, the average primary particle size is calculated using the average value of these as the particle diameter.

Incidentally, the average primary particle size of the untreated highly dielectric inorganic particles in the intermediate transfer belt can be determined by taking out the surface-treated highly dielectric inorganic particles from the intermediate transfer belt, removing the surface treatment layer, taking out only the untreated highly dielectric inorganic particles, and performing the above-described measurement. In addition, the average primary particle size of the untreated highly dielectric inorganic particles in the state of an intermediate transfer belt can be determined by cutting the intermediate transfer belt in the thickness direction of the belt using a general-purpose section cutter for scanning electron microscope (SEM) sample preparation, observing the cross section under a scanning electron microscope (SEM), and subjecting the untreated highly dielectric inorganic particle portion of the surface-treated highly dielectric inorganic particles to the above-described measurement.

As the untreated highly dielectric inorganic particles, a synthetic product may be used or a commercially available product may be used.

The untreated highly dielectric inorganic particles can be used singly or in combination of two or more kinds thereof.

The surface-treated highly dielectric inorganic particles refer to one obtained by subjecting untreated highly dielectric inorganic particles to at least one surface treatment selected from the group consisting of the metal oxide surface treatment and the coupling agent surface treatment.

The metal oxide to be fixed or supported on the surface of the highly dielectric inorganic particles by the metal oxide surface treatment is aluminum oxide (alumina), zinc oxide, tin oxide, lead oxide, silicon oxide (silica), zirconium oxide, and titanium oxide. Among these, alumina, zinc oxide, tin oxide, and lead oxide are preferable and alumina is more preferable from the viewpoint of further improving the transferability and thin paper separating property of the belt. In other words, the surface-treated highly dielectric inorganic particles more preferably contain alumina on the surface. These metal oxides may be in a hydrated state, and an example of a metal oxide in a hydrated state includes hydrated alumina (Al₂O₃•nH₂O).

The reason why the transfer property and thin paper separating property of the intermediate transfer belt are improved by these metal oxides is presumed as follows. This is because these metal oxides exhibit high affinity for at least one resin selected from the group consisting of polyimide, polyamide-imide, and polyetherimide, as a result, the uniformity in the existing state of the surface-treated highly dielectric inorganic particles in the substrate is improved.

The metal oxides can be used singly or in combination of two or more kinds thereof.

The chemical species to exist on the surface of the highly dielectric inorganic particles by the metal oxide surface treatment can be confirmed by cutting the intermediate transfer belt in the thickness direction of the belt by an appropriate method such as a general-purpose section cutter for scanning electron microscope (SEM) sample preparation, ion milling, microtome or the like, observing the cross section under a scanning electron microscope (SEM), identifying the highly dielectric inorganic fine particles, and performing elemental analysis by EDS (energy dispersive X-ray spectroscopy) or the like.

Moreover, the amount of the metal oxide present on the surface of the highly dielectric inorganic particles is not particularly limited but is preferably an amount attained as a result of the surface treatment performed using the metal oxide in a preferable surface treatment amount to be described later.

The coupling agent to be fixed or supported on the surface of the highly dielectric inorganic particles by the coupling agent surface treatment is not particularly limited, and a known coupling agent can be used. Among these, a silane coupling agent, a titanate coupling agent, and an aluminate coupling agent are preferable and a silane coupling agent is more preferable from the viewpoint of further improving the transferability and thin paper separating property of the intermediate transfer belt.

The reason why the transfer property and thin paper separating property of the intermediate transfer belt are improved by a coupling agent is presumed as follows. This is because highly dielectric inorganic particles generally exhibit high aggregability, but the aggregation thereof is less likely to occur as a coupling agent exists in the vicinity of the particles, and as a result, the uniformity in the existing state of the surface-treated highly dielectric inorganic particles in the substrate is improved.

The silane coupling agent is not particularly limited, and examples thereof include vinyltrimethoxysilane, vinyltriethoxysilane, 3-(meth)acryloxypropyltrimethoxysilane, 3-mercaptopropyltrimethoxysilane, bis(3-(triethoxysilyl)propyl)tetrasulfide, p-styryltrimethoxysilane, 3-(meth)acryloxypropylmethyldimethoxysilane, 3-(meth)acryloxypropylmethyldiethoxysilane, 3-(meth)acryloxypropyltriethoxysilane, N-2-(aminoethyl)-3-aminopropylmethyldimethoxysilane, N-2-(aminoethyl)-3-aminopropyltrimethoxysilane, 3-aminopropyltrimethoxysilane, 3-aminopropyltriethoxysilane, 3-triethoxysilyl-N-(1,3-dimethyl-butylidene)propylamine, N-phenyl-3-aminopropyltrimethoxysilane, N-(vinylbenzyl)-2-aminoethyl-3-aminopropyltrimethoxysilane hydrochloride, tris-(trimethoxysilylpropyl)isocyanurate, 3-ureidopropyl trialkoxysilane, 3-mercaptopropylmethyldimethoxysilane, 3-isocyanatopropyltriethoxysilane, 3-glycidoxypropyltrimethoxysilane, 2-(3,4-epoxycyclohexyl)ethyltrimethoxysilane, 3-glycidoxypropylmethyldimethoxysilane, 3-glycidoxypropylmethyldiethoxysilane, 3-glycidoxypropyltriethoxysilane, and the like. Among these, 3-aminopropyltrimethoxysilane, 3-isocyanatopropyltriethoxysilane, or 3-glycidoxypropyltriethoxysilane is preferable and 3-aminopropyltrimethoxysilane is more preferable.

The titanate coupling agent is not particularly limited, and examples thereof include isopropyl triisostearoyl titanate, isopropyl tris(dioctyl pyrophosphate) titanate), bis(dioctylpyrophosphate) oxyacetate titanate, tris(dioctylpyrophosphate) ethylene titanate, isopropyldioctylpyrophosphate titanate, isopropyl tris(dodecylbenzenesulfonyl) titanate titanium tetranormal butoxide, titanium tetra-2-ethylhexoxide, and the like.

The aluminate coupling agent is not particularly limited, and example thereof include acetoalkoxyaluminum diisopropylate and the like.

As the coupling agent, a synthetic product may be used or a commercially available product may be used. Examples of commercially available products of coupling agent include KBM-403, KBE-403, KBM-903, KBE-903, KBM-9007, KBE-9007N, and KBE-9103P manufactured by Shin-Etsu Chemical Co., Ltd., and the like, but the commercially available products are not limited to these.

The silane coupling agent can be used singly or in combination of two or more kinds thereof.

The surface-treated highly dielectric inorganic particles are not particularly limited but preferably contain a nitrogen element on the surface and more preferably have an amino group on the surface. The transferability and thin paper separating property of the intermediate transfer belt can be further improved as these chemical species exist on the surface.

Hence, the coupling agent to be used in the coupling agent surface treatment preferably contains a nitrogen atom in the molecule, more preferably has an amino group in the molecule, still more preferably is a silane coupling agent having an amino group in the molecule, yet more preferably is 3-(meth)acryloxypropylmethyldiethoxysilane, 3-(meth)acxypropyltriethoxysilane, N-2-(aminoethyl)-3-aminopropylmethyldimethoxysilane, N-2-(aminoethyl)-3-aminopropyltrimethoxysilane, 3-aminopropyltrimethoxysilane, 3-aminopropyltriethoxysilane, 3-triethoxysilyl-N-(1,3-dimethyl-butylidene)propylamine, N-phenyl-3-aminopropyltrimethoxysilane, or N-(vinylbenzyl)-2-aminoethyl-3-aminopropyltrimethoxysilane hydrochloride, and particularly preferably is 3-aminopropyltrimethoxy silane.

These surface treatments can be performed singly or in combination of two or more of the same or different surface treatments of the metal oxide surface treatment and the coupling agent surface treatment. Hence, it is preferable that the surface-treated highly dielectric inorganic particles have been subjected to both the metal oxide surface treatment and the coupling agent surface treatment and it is more preferable that the surface-treated highly dielectric inorganic particles have been subjected to the metal oxide surface treatment and then to the coupling agent surface treatment.

The chemical species to exist on the surface of the highly dielectric inorganic particles by the coupling agent surface treatment can be confirmed by cutting the intermediate transfer belt in the thickness direction of the belt by an appropriate method such as a general-purpose section cutter for scanning electron microscope (SEM) sample preparation, ion milling, microtome or the like, observing the cross section under a scanning electron microscope (SEM), identifying the highly dielectric inorganic fine particles, and performing elemental analysis by EDS (energy dispersive X-ray spectroscopy) or the like.

The amount of the coupling agent present on the surface of the highly dielectric inorganic particles is not particularly limited but is preferably an amount attained as a result of the surface treatment performed using the coupling agent in a preferable surface treatment amount to be described later.

The lower limit of the content of the surface-treated highly dielectric inorganic particles in the substrate is not particularly limited but is preferably 1 part by mass or more, more preferably 10 parts by mass or more, and still more preferably 100 parts by mass or more with respect to 100 parts by mass of at least one resin selected from the group consisting of polyimide, polyimide-imide, and polyetherimide from the viewpoint of further improving the transferability of the intermediate transfer belt. In addition, the upper limit of the content of the surface-treated highly dielectric inorganic particles in the substrate is not particularly limited but is preferably 1,000 parts by mass or less, more preferably 500 parts by mass or less, and still more preferably 200 parts by mass or less with respect to 100 parts by mass of at least one resin selected from the group consisting of polyimide, polyamide-imide, and polyetherimide from the viewpoint of further improving the transferability and thin paper separation property of the intermediate transfer belt.

(Conductive Agent)

The substrate included in the intermediate transfer belt according to an embodiment of the present invention preferably further contains a conductive agent. By adding a conductive agent, the resistance value of the intermediate transfer belt can be adjusted to a range more suitable for transfer, and as a result, the transferability of the intermediate transfer belt is further improved.

The conductive agent is not particularly limited, and a known conductive agent can be used. Examples thereof include metals such as silver, copper, aluminum, magnesium, nickel, stainless steel, those containing a carbon element such as compounds containing carbon such as graphite, carbon black, carbon nanofiber, carbon nanotube, and the like. Among these, a conductive agent containing a carbon element is preferable, a carbon compound is more preferable, and carbon black is still more preferable from the viewpoint of further improving the transferability and mechanical properties.

As the conductive agent, a synthetic product may be used or a commercially available product may be used. Examples of commercially available products include SPECIAL BLACK4 manufactured by Degussa AG, NIPex (registered trademark) 150 manufactured by Evonik Japan Co., Ltd., and the like, for example, as carbon black, but the commercially available products are not limited to these.

The conductive agent can be used singly or in combination of two or more kinds thereof.

The lower limit of the content of the conductive agent in the substrate is not particularly limited but is preferably 0.1 part by mass or more, more preferably 0.5 part by mass or more, and still more preferably 1 part by mass or more with respect to 100 parts by mass of at least one resin selected from the group consisting of polyimide, polyamide-imide, and polyetherimide from the viewpoint of further improving the transferability of the intermediate transfer belt. In addition, the upper limit of the content of the conductive agent in the substrate is not particularly limited but is preferably 50 parts by mass or less, more preferably 20 parts by mass or less, and still more preferably 10 parts by mass or less with respect to 100 parts by mass of at least one resin selected from the group consisting of polyimide, polyamide-imide, and polyetherimide from the viewpoint of further improving the mechanical properties of the intermediate transfer belt.

(Surfactant)

The substrate included in the intermediate transfer belt according to an embodiment of the present invention preferably further contains a surfactant. A surfactant acts to more uniformly disperse the surface-treated highly dielectric inorganic particles and the conductive agent in the substrate.

The surfactant is not particularly limited, and a known surfactant can be used. Among these, a fluorine-containing organic compound is preferable.

As the surfactant, a synthetic product may be used or a commercially available product may be used. Examples of commercially available products include F-Top (registered trademark) EF-351 manufactured by Mitsubishi Materials Corporation, and the like as a fluorine-containing organic compound, but the commercially available products are not limited to these.

The surfactant can be used singly or in combination of two or more kinds thereof.

The lower limit of the content of the surfactant in the substrate is not particularly limited but is preferably 0.001 part by mass or more, more preferably 0.005 part by mass or more, and still more preferably 0.01 part by mass or more with respect to 100 parts by mass of at least one resin selected from the group consisting of polyimide, polyamide-imide, and polyetherimide from the viewpoint of further improving the transferability and thin paper separating property of the intermediate transfer belt. In addition, the upper limit of the content of the surfactant in the substrate is not particularly limited but is preferably 1 part by mass or less, more preferably 0.5 part by mass or less, and still more preferably 0.1 part by mass or less with respect to 100 parts by mass of at least one resin selected from the group consisting of polyimide, polyamide-imide, and polyetherimide from the viewpoint of further improving the mechanical properties.

(Other Components)

The substrate included in the intermediate transfer belt according to an embodiment of the present invention may further contain other components which can be contained in a known substrate as long as the effects of the present invention are not impaired. Examples of other components include an antioxidant, a filler, a lubricant, a dye, an organic pigment, an inorganic pigment, a plasticizer, a leveling agent, a processing auxiliary, an ultraviolet absorber, a light stabilizer, a foaming agent, a wax, a crystal nucleating agent, a release agent, a hydrolysis inhibitor, an antiblocking agent, an antistatic agent, a radical scavenger, an antifogging agent, an antifungal agent, an ion trapping agent, a flame retardant, a flame retardant auxiliary and the like, but other components are not limited to these. The content of other components may be appropriately set so as to attain desired properties as long as the effects of the present invention are not impaired.

### [Other Layers]

The intermediate transfer belt according to an embodiment of the present invention may further include other layers which can be included in a known intermediate transfer belt as long as the effects of the present invention are not impaired.

Examples of other layers include an elastic layer, a surface layer and the like, but other layers are not limited to these. Here, the elastic layer is a layer which can be formed of a material containing a thermoplastic elastomer (TPE) as a main component, a material containing vulcanized rubber as a main component, a polymer material foam or the like and acts to further improve the transferability by being deformed to correspond to the thickness of the recording medium (for example, paper). Moreover, the surface layer is usually formed on the surface of the elastic layer and can protect the elastic layer and proper flexibility to be deformed in accordance with the deformation of the elastic layer and sufficient durability (mechanical strength, releasability and the like) with respect to contact can be imparted to the surface layer, for example, in a case in which the surface layer is composed of an acrylic material.

The kinds, compositions, properties, and the like of other layers may be appropriately set so as to attain desired properties as long as the effects of the present invention are not impaired.

### [Method for Manufacturing Intermediate Transfer Belt]

Another embodiment of the present invention relates to a method for manufacturing the intermediate transfer belt described above, which includes subjecting highly dielectric inorganic particles to at least one surface treatment selected from the group consisting of a surface treatment with an oxide of at least one metal selected from the group consisting of aluminum, zinc, tin, lead, silicon, zirconium, and titanium (metal oxide surface treatment) and a surface treatment with a coupling agent (coupling agent surface treatment) to obtain the highly dielectric inorganic particles subjected to at least one surface treatment (surface-treated highly dielectric inorganic particles) and forming a substrate containing the highly dielectric inorganic particles subjected to at least one surface treatment and at least one material selected from the group consisting of polyimide, polyamide-imide, polyetherimide, and any precursor of these. The details of the surface-treated highly dielectric inorganic particles to be manufactured in this form are similar to the description of the surface-treated highly dielectric inorganic particles described above.

(Metal Oxide Surface Treatment)

The manufacturing method according to an embodiment of the present invention preferably includes subjecting highly dielectric inorganic particles to the metal oxide surface treatment to obtain surface-treated highly dielectric inorganic particles. Here, the highly dielectric inorganic particles to be subjected to the metal oxide surface treatment may be untreated highly dielectric inorganic particles or surface-treated highly dielectric inorganic particles. Moreover, as the highly dielectric inorganic particles to be subjected to the metal oxide surface treatment, untreated highly dielectric inorganic particles and surface-treated highly dielectric inorganic particles may be used concurrently.

The metal oxide surface treatment method is not particularly limited, a known surface treatment method for particles using a metal oxide can be used, and examples thereof include the method described in JP H03-275768 A, the method described in JP 2007-09156 A, and the like.

Among these, a method is preferable in which a dispersion containing highly dielectric inorganic particles and a metal oxide precursor are mixed to prepare a mixed dispersion, a pH adjusting agent is added to this mixed dispersion so as to keep the pH of the mixed dispersion in a certain range, and the mixed dispersion is aged for a certain period of time.

The dispersion medium of the dispersion containing highly dielectric inorganic particles preferably contains water and more preferably is composed only of water. Moreover, the concentration of the highly dielectric inorganic particles in the dispersion is not particularly limited but is preferably 1% by mass or more, more preferably 5% by mass or more, and still more preferably 10% by mass or more with respect to the total mass of the dispersion. The metal oxide surface treatment can be more efficiently performed when the concentration is in this range. Moreover, the concentration of the highly dielectric inorganic particles in the dispersion is not particularly limited but is preferably 60% by mass or less, more preferably 40% by mass or less, and still more preferably 30% by mass or less with respect to the total mass of the dispersion. The metal oxide surface treatment can be more efficiently performed when the concentration is in this range. When the concentration is in this range, a more uniform surface treatment is possible and the surface-treated state is more favorable. Incidentally, other additives may be contained in the dispersion containing highly dielectric inorganic particles if necessary.

The metal oxide precursor may be added to the dispersion containing highly dielectric inorganic particles as it is but is preferably added in the form of a solution (dispersion). The solvent (dispersion medium) for the solution (dispersion) containing a metal oxide precursor preferably contains water and more preferably is composed only of water. Moreover, the concentration of the metal oxide precursor in the solution (dispersion) is not particularly limited and may be appropriately set according to the kinds of metal oxide and highly dielectric inorganic particles and the reaction method.

The metal oxide precursor is preferably a water-soluble metal salt. The water-soluble metal salt (water-soluble aluminum salt) to be used in the surface treatment with aluminum oxide is not particularly limited, and examples thereof include sodium aluminate, aluminum sulfate, aluminum nitrate, aluminum chloride and the like. The water-soluble metal salt (water-soluble zinc salt) to be used in the surface treatment with zinc oxide is not particularly limited, and examples thereof include zinc sulfate and the like. The water-soluble metal salt (water-soluble tin salt) to be used in the surface treatment with tin oxide is not particularly limited, and examples thereof include tin sulfate, tin nitrate, tin acetate, tin oxychloride and the like. The water-soluble metal salt (water-soluble lead salt) to be used in the surface treatment with lead oxide is not particularly limited, and examples thereof include lead nitrate, lead acetate and the like. The water-soluble metal salt (water-soluble silicate) to be used in the surface treatment with silicon oxide is not particularly limited, and examples thereof include sodium silicate, potassium silicate and the like. The water-soluble metal salt (water-soluble zirconium salt) to be used in the surface treatment with zirconium oxide is not particularly limited, and examples thereof include zirconium sulfate, zirconium nitrate, zirconium chloride, zirconium oxychloride and the like. The water-soluble metal salt (water-soluble titanium salt) to be used in the surface treatment with titanium oxide is not particularly limited, and examples thereof include titanium tetrachloride, titanium sulfate and the like. Among these, a water-soluble aluminum salt, a water-soluble zinc salt, a water-soluble tin salt, and a water-soluble lead salt are preferable, a water-soluble aluminum salt is more preferable, and sodium aluminate is still more preferable.

As the metal oxide precursor, a synthetic product may be used or a commercially available product may be used.

The metal oxide precursor can be used singly or in combination of two or more kinds thereof.

The surface treatment amount of highly dielectric inorganic particles is not particularly limited, but the amount of metal oxide precursor is set to preferably 0.1 part by mass or more, more preferably 0.5 part by mass or more, and still more preferably 1 part by mass or more in terms of metal oxide with respect to 100 parts by mass of the highly dielectric inorganic particles (surface-treated highly dielectric inorganic particles in a case in which the surface-treated highly dielectric inorganic particles are subjected to the surface treatment). The transferability and thin paper separating property of the intermediate transfer belt are further improved when the surface treatment amount is in this range. The reason for this is presumed to be because the surface treatment is more sufficiently performed. Moreover, the surface treatment amount of highly dielectric inorganic particles is not particularly limited, but the amount of metal oxide precursor is set to preferably 100 parts by mass or less, more preferably 50 parts by mass or less, and still more preferably 10 parts by mass or less in terms of metal oxide with respect to 100 parts by mass of the highly dielectric inorganic particles (surface-treated highly dielectric inorganic particles in a case in which the surface-treated highly dielectric inorganic particles are subjected to the surface treatment). The production efficiency is further improved when the surface treatment amount is in this range. Incidentally, the amount of metal oxide precursor is a value in terms of the amount of metal oxide which is not in a hydrated state even in a case in which a metal oxide in a hydrated state is obtained after the metal oxide surface treatment.

The temperature at which the dispersion containing highly dielectric inorganic particles and the metal oxide precursor are mixed is not particularly limited and may be appropriately set according to the kinds of metal oxide and highly dielectric inorganic particles and the reaction method.

In a case in which a water-soluble metal salt is used as the metal oxide precursor, the metal oxide surface treatment is preferably performed by neutralizing the water-soluble metal salt. Examples of a specific method thereof include a method in which a water-soluble metal salt and a pH adjusting agent are simultaneously added, a method in which a pH adjusting agent is added after the addition of a water-soluble metal salt, and the like. Among these, a method in which a pH adjusting agent is added after the addition of a water-soluble metal salt is preferable from the viewpoint of being able to perform a more uniform surface treatment and of attaining a more favorable surface-treated state.

The pH adjusting agent is preferably a compound capable of neutralizing the water-soluble metal salt. As such a compound, known acids or bases can be used. The pH adjusting agent is not particularly limited, and examples thereof include acidic compounds such as inorganic acids such as sulfuric acid, hydrochloric acid, nitric acid, organic acids such as acetic acid, formic acid, propionic acid, basic compounds such as hydroxides or carbonates of alkali metals or alkaline earth metals, ammonium compounds, and the like. Among these, inorganic acids are preferable and sulfuric acid is more preferable.

The pH adjusting agent may be added as it is but is preferably added in the form of a solution. The solvent of the solution containing a pH adjusting agent preferably contains water and more preferably is composed only of water. Moreover, the concentration of the pH adjusting agent in the solution is not particularly limited, may be appropriately set according to the kinds of metal oxide and highly dielectric inorganic particles and the reaction method, and may be set to, for example, 0.1 to 10 N (0.1 g/L to 10 g/L).

The addition of the pH adjusting agent is preferably performed while maintaining the pH of the mixed dispersion to which the pH adjusting agent is added in a certain range. The range of the pH value is not particularly limited but is preferably 4.5 to 9.5, more preferably 4.5 to 9.0, and still more preferably 5.0 to 8.0 from the viewpoint of being able to perform a more uniform surface treatment and of attaining a more favorable surface-treated state.

The temperature (neutralization temperature) at which the neutralization reaction is performed by the addition of pH adjusting agent is not particularly limited and may be appropriately set according to the kinds of metal oxide and highly dielectric inorganic particles and the reaction method.

After the addition of pH adjusting agent is terminated, the dispersion obtained is preferably aged for a certain period of time.

Aging is preferably performed while performing stirring.

The aging period is not particularly limited but is preferably 1 minute or more, more preferably 10 minutes or more, and still more preferably 30 minutes or more from the viewpoint of being able to perform a more uniform surface treatment and of attaining a more favorable surface-treated state. In addition, the aging period is not particularly limited but is preferably 3,600 minutes or less, more preferably 360 minutes or less, and still more preferably 180 minutes or less from the viewpoint of production efficiency.

The temperature (aging temperature) at which aging is performed is not particularly limited and may be appropriately set according to the kinds of metal oxide and highly dielectric inorganic particles and the reaction method.

After aging, it is preferable that the surface-treated highly dielectric inorganic particles are taken out by filtering the dispersion obtained, washed with pure water or the like if necessary, then subjected to drying by heating, and then pulverized. The conditions for drying by heating are not particularly limited, but the drying temperature is preferably 100° C. to 200° C. and the drying time is preferably 1 to 72 hours. Moreover, the pulverization method is not particularly limited, and as an example, pulverization can be performed using an automatic mortar (ANM1000 manufactured by NITTO KAGAKU CO., LTD.) or the like.

(Coupling Agent Surface Treatment)

The manufacturing method according to an embodiment of the present invention preferably includes subjecting highly dielectric inorganic particles to the coupling agent surface treatment to obtain surface-treated highly dielectric inorganic particles. Here, the highly dielectric inorganic particles to be subjected to the coupling agent surface treatment may be untreated highly dielectric inorganic particles or surface-treated highly dielectric inorganic particles. Moreover, as the highly dielectric inorganic particles to be subjected to the coupling agent surface treatment, untreated highly dielectric inorganic particles and surface-treated highly dielectric inorganic particles may be used concurrently.

The coupling agent surface treatment method is not particularly limited, and a known method can be used. Among these, the coupling agent surface treatment method is preferably a method in which a dispersion containing highly dielectric inorganic particles is mixed with a solution (dispersion) containing a coupling agent and the mixed dispersion obtained is allowed to age for a certain period of time.

The dispersion medium of the dispersion containing highly dielectric inorganic particles preferably contains an organic solvent or water and more preferably contains an organic solvent. The organic solvent is not particularly limited, and examples thereof include an alcohol-based solvent, an ester-based solvent, a ketone-based solvent and the like. Among these, an alcohol-based solvent is preferable. The alcohol-based solvent is not particularly limited, and examples thereof include methanol, ethanol, 1-propanol, 2-propanol, n-butanol, tert-butanol, sec-butanol, ethylene glycol, 1,2-propanediol, 1,3-propanediol, 1,3-butanediol, 1,4-butanediol, 2,3-butanediol, 1,5-pentanediol, 2-butene-1,4-diol, 2-methyl-2,4-pentanediol, 1,2,6-hexanetriol, benzyl alcohol and the like. Among these, methanol, ethanol, 1-propanol, 2-propanol, n-butanol, tert-butanol, and sec-butanol are preferable and methanol is more preferable. These organic solvents can be used singly or in combination of two or more kinds thereof.

Moreover, the concentration of highly dielectric inorganic particles in the dispersion containing highly dielectric inorganic particles is not particularly limited but is preferably 1% by mass or more, more preferably 5% by mass or more, and still more preferably 10% by mass or more with respect to the total mass of the dispersion. The metal oxide surface treatment can be more efficiently performed when the concentration is in this range. Moreover, the concentration of highly dielectric inorganic particles in the dispersion is not particularly limited but is preferably 80% by mass or less, more preferably 60% by mass or less, and still more preferably 50% by mass or less with respect to the total mass of the dispersion. The metal oxide surface treatment can be more efficiently performed when the concentration is in this range.

Incidentally, other additives may be contained in the dispersion containing highly dielectric inorganic particles if necessary.

The dispersion medium of the solution (dispersion) containing a coupling agent preferably contains an organic solvent or water and more preferably contains an organic solvent and water. The organic solvent is not particularly limited, and examples thereof include an alcohol-based solvent, an ester-based solvent, a ketone-based solvent and the like. Among these, an alcohol-based solvent is preferable. The alcohol-based solvent is not particularly limited but examples thereof include those similar to the dispersion mediums of the dispersion containing highly dielectric inorganic particles. Among these, methanol, ethanol, 1-propanol, 2-propanol, n-butanol, tert-butanol, and sec-butanol are preferable and methanol is more preferable. In particular, it is preferable that the organic solvent to be contained in the solution (dispersion) containing a coupling agent is the same as the organic solvent to be contained in the dispersion containing highly dielectric inorganic particles.

When the solvent (dispersion medium) of the solution (dispersion) containing a coupling agent is an organic solvent and water, the content of water with respect to the total mass of the solvent (dispersion medium) is preferably 0.01% by mass or more, more preferably 0.05% by mass or more, and still more preferably 0.1% by mass or more. The coupling agent surface treatment can be more efficiently performed when the content is in this range. For example, in a coupling agent having an alkoxy group, the alkoxy group converts to a silanol and easily forms a hydrogen bond with a hydroxyl group on the surface of the inorganic particles. In addition, the content of water with respect to the total mass of the solvent (dispersion medium) is preferably 10% by mass or less, more preferably 5% by mass or less, and still more preferably 1% by mass or less. When the content is in this range, the economic efficiency is further improved while a sufficient surface treatment amount is maintained.

Moreover, the concentration of the coupling agent in the solution (dispersion) containing a coupling agent is not particularly limited but is preferably 0.1% by mass or more, more preferably 0.5% by mass or more, and still more preferably 1% by mass or more with respect to the total mass of the solution (dispersion). The coupling agent surface treatment can be more efficiently performed when the content is in this range. Moreover, the concentration of the coupling agent in the solution (dispersion) is not particularly limited but is preferably 30% by mass or less, more preferably 15% by mass or less, and still more preferably 10% by mass or less with respect to the total mass of the solution (dispersion). The coupling agent surface treatment can be more efficiently performed when the content is in this range.

It is preferable that the solution (dispersion) containing a coupling agent further contains an acidic compound. The acidic compound is not particularly limited, and a known acidic compound can be used. Examples of the acidic compound include inorganic acids such as sulfuric acid, hydrochloric acid, nitric acid, organic acids such as acetic acid, formic acid, propionic acid, and the like. Among these, organic acids are preferable and acetic acid is more preferable.

Incidentally, other additives may be contained in the solution (dispersion) containing a coupling agent if necessary.

The temperature at which the dispersion containing highly dielectric inorganic particles and the solution (dispersion) containing a coupling agent are mixed is not particularly limited and may be appropriately set according to the kinds of coupling agent and highly dielectric inorganic particles and the reaction method.

After the dispersion containing highly dielectric inorganic particles and the solution (dispersion) containing a coupling agent are mixed, the mixed dispersion obtained is preferably allowed to age for a certain period of time.

Aging is preferably performed while performing stirring.

The aging period is not particularly limited but is preferably 1 minute or more, more preferably 10 minutes or more, and still more preferably 30 minutes or more from the viewpoint of being able to perform a more uniform surface treatment and of attaining a more favorable surface-treated state. In addition, the aging period is not particularly limited but is preferably 3,600 minutes or less, more preferably 360 minutes or less, and still more preferably 180 minutes or less from the viewpoint of production efficiency.

The temperature at which aging is performed is not particularly limited and may be appropriately set according to the kinds of coupling agent and highly dielectric inorganic particles and the reaction method.

After aging, it is preferable that the dispersion obtained is dried under reduced pressure to evaporate the solvent, then subjected to drying by heating, and then pulverized. The conditions for drying by heating are not particularly limited, but the drying temperature is preferably 100° C. to 200° C. and the drying time is preferably 0.5 to 24 hours. Moreover, the pulverization method is not particularly limited, and as an example, pulverization can be performed using an automatic mortar (ANM1000 manufactured by NITTO KAGAKU CO., LTD.) or the like.

It is also preferable that the coupling agent surface treatment is performed by a method in which powdery highly dielectric inorganic particles and a coupling agent are mechanically mixed and stirred. At this time, the coupling agent may be in the form of a powder, or in the form of a solution (dispersion liquid) containing the coupling agent or a partial hydrolyzate obtained therefrom. And, it is also preferable that the coupling agent surface treatment is performed by a method in which mechanical mixing and stirring is performed while spraying a coupling agent onto powdery highly dielectric inorganic particles. In these methods, approximately the entire amount of the coupling agent added is coated on the surface of highly dielectric inorganic particles. In addition, the method may be a method in which highly dielectric inorganic particles, at least one material selected from the group consisting of polyimide, polyamide-imide, polyetherimide, and any precursor of these, and the coupling agent are mixed at a time.

In order to uniformly coat the surface of highly dielectric inorganic particles with a coupling agent, it is preferable that the aggregation of the powdery highly dielectric inorganic particles is previously disentangled using a pulverizer.

The instrument for mixing the powdery highly dielectric inorganic particles and the coupling agent is not particularly limited but is preferably a device capable of applying a shearing force to the powder (a mixture containing the powdery highly dielectric inorganic particles and the coupling agent). Among these, devices capable of simultaneously performing shearing, kneading with spatula, and compression, for example, a wheel-type kneader, a ball-type kneader, a blade-type kneader, and a roll-type kneader are more preferable, and a wheel-type kneader is still more preferable.

Examples of a wheel-type kneader include an edge runner (synonymous with “mix muller”, “Simpson mill”, and “sand mill”), a multi mill, a Stotts mill, a wet pan mill, a corner mill, a ring muller and the like. Among these, an edge runner, a multi mill, a Stotts mill, a wet pan mill, and a ring muller are preferable and an edge runner is more preferable. Examples of the ball-type kneader include a vibration mill and the like. Examples of the blade-type kneader include a Henschel mixer, a planetary mixer, a Nauta mixer and the like. Examples of the roll-type kneader include an extruder and the like.

The treatment conditions at the time of mixing are not particularly limited as long as the highly dielectric inorganic particles can be coated with the coupling agent. The treatment time may be appropriately adjusted, and as an example, the treatment time is preferably 5 to 120 minutes and more preferably 10 to 90 minutes. In addition, the stirring speed may be appropriately adjusted, and as an example, the stirring speed is preferably 2 to 2,000 rpm, more preferably 5 to 1000 rpm, and still more preferably 10 to 800 rpm. Incidentally, an example of the peripheral speed of the stirring member is preferably 1 to 100 msec.

In addition, examples of the device capable of applying a shearing force to the powder at a high speed include a high-speed shearing mill, a blade-type kneader, a planetary mill and the like. Among these, a high-speed shearing mill is preferable.

Examples of the high-speed shearing mill include a hybridizer, NOBILTA (manufactured by HOSOKAWA MICRON CORPORATION), and the like.

The treatment conditions of the device capable of applying a shearing force to the powder at a high speed are not particularly limited. The stirring speed at the time of mixing may be appropriately adjusted. As an example of the stirring speed, a stirring speed of 100 to 100,000 rpm is preferable and a stirring speed of 1,000 to 50,000 rpm is more preferable. The treatment time may be appropriately adjusted. As an example of the treatment time, a treatment time of 1 to 120 minutes is preferable and a treatment time of 2 to 90 minutes is more preferable.

At the time of mixing treatment or after the termination of mixing treatment, a drying by heating treatment may be further performed. The heating temperature is not particularly limited and may be appropriately adjusted, but as an example, the heating temperature is preferably 50° C. to 200° C.

Incidentally, the coupling agent and highly dielectric inorganic particles to be used in the coupling agent surface treatment are each similar to those described in the description of the intermediate transfer belt.

Moreover, the surface treatment amount of highly dielectric inorganic particles is not particularly limited, but the amount of coupling agent is set to preferably 0.1 part by mass or more, more preferably 1 part by mass or more, still more preferably 3 parts by mass or more, and particularly preferably 5 parts by mass or more with respect to 100 parts by mass of the highly dielectric inorganic particles (surface-treated highly dielectric inorganic particles in a case in which the surface-treated highly dielectric inorganic particles are subjected to the surface treatment). The transferability and thin paper separating property of the intermediate transfer belt are further improved when the surface treatment amount is in this range. The reason for this is presumed to be because the surface treatment is more sufficiently performed. Moreover, the surface treatment amount of highly dielectric inorganic particles is not particularly limited, but the amount of coupling agent is set to preferably 100 parts by mass or less, more preferably 60 parts by mass or less, still more preferably 30 parts by mass or less, and particularly preferably 20 parts by mass or less with respect to 100 parts by mass of the highly dielectric inorganic particles (surface-treated highly dielectric inorganic particles in a case in which the surface-treated highly dielectric inorganic particles are subjected to the surface treatment). The production efficiency is further improved when the surface treatment amount is in this range.

(Order of Surface Treatment)

In the manufacturing method according to an embodiment of the present invention, in a case in which both the metal oxide surface treatment and the coupling agent surface treatment are performed, either of these may be performed first. However, it is preferable to perform the coupling agent surface treatment after the metal oxide surface treatment from the viewpoint of further improving the transferability and thin paper separating property of the intermediate transfer belt. It is presumed that this is because a more uniform surface treatment is possible and a more favorable surface-treated state can be attained by performing the surface treatments in this order.

(Formation of Substrate)

The method for manufacturing an intermediate transfer belt according to an embodiment of the present invention includes forming a substrate containing the surface-treated highly dielectric inorganic particles and at least one material selected from the group consisting of polyimide, polyamide-imide, polyetherimide, and any precursor of these.

The method for forming a substrate is not particularly limited, and a known substrate forming method can be used. Examples thereof include a method including a coating film forming step, a drying and firing step and the like, and the like.

Examples the coating film forming step include a method in which the inner peripheral surface or outer peripheral surface of a cylindrical mold is immersed in a coating liquid for substrate formation to form a coating film. Examples thereof also include a method in which the inner peripheral surface or outer peripheral surface is coated with a coating liquid for substrate formation to form a coating film and a method in which a coating film is formed by further performing centrifugation if necessary. Examples thereof further include a method in which the dispense nozzle is moved in the axial direction while rotating the cylindrical mold around the cylindrical axis, a coating liquid for substrate formation is sprayed onto the inner peripheral surface or outer peripheral surface of the mold through the nozzle to coat the surface in a spiral shape, and an endless belt-like coating film is thus formed in which these coating films are linked with each other. Among these methods, a method in which coating is performed on the inner peripheral surface of a cylindrical mold is preferable. However, the coating film forming step is not limited to these.

Moreover, examples of the drying step include a method in which the coating film formed on the cylindrical mold is dried by heating while being rotated around the cylindrical axis if necessary and a method in which the coating film is further subjected to a heat treatment (for example, a thermal imidization treatment or the like) after this method if necessary. However, the coating film forming step is not limited to these.

Moreover, when an endless belt-like substrate is manufactured, appropriate treatments such as a mold release treatment, a defoaming treatment and the like can be performed.

The coating liquid for substrate formation contains at least one material selected from the group consisting of polyimide, polyamide-imide, polyetherimide, and any precursor of these, surface-treated highly dielectric inorganic particles, and a solvent. Moreover, the coating liquid for substrate formation may further contain a conductive agent, a surfactant, and other components if necessary. These components are similar to those described in the description of the intermediate transfer belt.

The solid concentration in the coating liquid for substrate formation is not particularly limited but

is preferably 0.1% by mass or more and 50% by mass or less, more preferably 1% by mass or more and 30% by mass or less, and still more preferably 5% by mass or more and 25% by mass or less with respect to the total mass of the coating liquid for substrate formation from the viewpoint of further enhancing the uniformity in the existing state of the surface-treated highly dielectric inorganic particles and conductive agent in the substrate and of improvement in coatability and a decrease in coating film damage.

Incidentally, the preferable ranges of the content ratios of the surface-treated highly dielectric inorganic particles, the conductive agent, and the surfactant with respect to 100 parts by mass of at least one material selected from the group consisting of polyimide, polyamide-imide, polyetherimide, and any precursor of these in the coating liquid for substrate formation are each similar to the preferable ranges of the content ratios with respect to 100 parts by mass of a resin selected from the group consisting of polyimide, polyamide-imide, and polyetherimide in the substrate of the intermediate transfer belt described above.

The method for preparing the coating liquid for substrate formation is not particularly limited, and a known method for preparing a dispersion can be used. Among these, it is preferable to prepare the coating liquid for substrate formation by mixing at least one material selected from the group consisting of polyimide, polyamide-imide, polyetherimide, and any precursor of these, a dispersion A containing the surface-treated highly dielectric inorganic particles (hereinafter, also referred to as “surface-treated highly dielectric inorganic particle dispersion A”), a dispersion B containing the conductive agent (hereinafter, also referred to as “conductive agent dispersion B”), and further other components if necessary. The mixing means, mixing method, and mixing conditions of these are not particularly limited, and known means, methods, and conditions can be appropriately employed. In addition, the mixing order of these is also not particularly limited.

In the preparation of the coating liquid for substrate formation, polyimide, polyamide-imide, polyetherimide, or any precursor of these may be added as it is but is preferably added in the form of a solution (dispersion). The solvent of the solution (dispersion) containing these resins is not particularly limited, and a known solvent can be used. Examples thereof include water, an alcohol-based solvent, an aromatic hydrocarbon-based solvent, a ketone-based solvent, a sulfoxide-based solvent, a formamide-based solvent, an acetamide-based solvent, a pyrrolidone-based solvent and the like. Among these, dimethyl sulfoxide, N,N′-dimethylacetamide, N,N′-dimethylformamide, and N-methyl-2-pyrrolidone are preferable and N-methyl-2-pyrrolidone is more preferable.

The concentration of these resins or precursors thereof in the solution (dispersion) containing these resins or precursors thereof is not particularly limited but is preferably 1% by mass or more and 50% by mass or less, more preferably 5% by mass or more and 40% by mass or less, and still more preferably 10% by mass or more and 30% by mass or less with respect to the total mass of the solution (dispersion) containing these resins or precursors thereof from the viewpoint of further enhancing the uniformity in the existing state of the surface-treated highly dielectric inorganic particles and conductive agent in the substrate.

Incidentally, other additives may be contained in the solution (dispersion) containing these resins or precursors thereof if necessary.

As the solution (dispersion) containing these resins or precursors thereof, a commercially available product may be used. Examples of commercially available products include UPIA (registered trademark)—AT1001, ST1001, ST1002, NF1001, NF2001, FN1001, FN2001, LB1001, LB2001 and the like manufactured by UBE INDUSTRIES, LTD., but the commercially available products are not limited to these.

The dispersion medium of the surface-treated highly dielectric inorganic particle dispersion A is not particularly limited, and a known dispersion medium can be used. Examples thereof include water, an alcohol-based solvent, an aromatic hydrocarbon-based solvent, a ketone-based solvent, a sulfoxide-based solvent, a formamide-based solvent, an acetamide-based solvent, a pyrrolidone-based solvent and the like. Among these, dimethyl sulfoxide, N,N′-dimethylacetamide, N,N′-dimethylformamide, and N-methyl-2-pyrrolidone are preferable and N-methyl-2-pyrrolidone is more preferable. In particular, the dispersion medium is preferably the same as the solvent (dispersion medium) contained in the solution (dispersion) containing at least one material selected from the group consisting of polyimide, polyamide-imide, polyetherimide, and any precursor of these.

The concentration of the surface-treated highly dielectric inorganic particles in the surface-treated highly dielectric inorganic particle dispersion A is not particularly limited but is preferably 1% by mass or more and 50% by mass or less, more preferably 5% by mass or more and 40% by mass or less, and still more preferably 10% by mass or more and 30% by mass or less with respect to the total mass of the surface-treated highly dielectric inorganic particle dispersion A from the viewpoint of further enhancing the uniformity in the existing state of the particles in the substrate.

Incidentally, other additives may be contained in the surface-treated highly dielectric inorganic particle dispersion A if necessary.

In the preparation of the surface-treated highly dielectric inorganic particle dispersion A, it is preferable to apply ultrasonic waves to the mixture after mixing of the surface-treated highly dielectric inorganic particles and the dispersion medium from the viewpoint of further improving the uniformity of the dispersion.

The dispersion medium of the conductive agent dispersion B is not particularly limited, and a known dispersion medium can be used. Examples thereof include water, an alcohol-based solvent, an aromatic hydrocarbon-based solvent, a ketone-based solvent, a sulfoxide-based solvent, a formamide-based solvent, an acetamide-based solvent, a pyrrolidone-based solvent and the like. Among these, dimethyl sulfoxide, N,N′-dimethylacetamide, N,N′-dimethylformamide, and N-methyl-2-pyrrolidone are preferable and N-methyl-2-pyrrolidone is more preferable. In particular, the dispersion medium is preferably the same as the solvent (dispersion medium) contained in the solution (dispersion) containing at least one material selected from the group consisting of polyimide, polyamide-imide, polyetherimide, and any precursor of these.

The concentration of the conductive agent in the conductive agent dispersion B is not particularly limited but is preferably 0.1% by mass or more and 50% by mass or less, more preferably 1% by mass or more and 40% by mass or less, and still more preferably 10% by mass or more and 30% by mass or less with respect to the total mass of the conductive agent dispersion B from the viewpoint of further enhancing the uniformity in the existing state of the conductive agent in the substrate.

It is preferable that the conductive agent dispersion B contains at least one material selected from the group consisting of polyimide, polyamide-imide, polyetherimide, and any precursor of these in addition to the conductive agent and the dispersion medium. This is because the conductive agent can be more uniformly dispersed in the substrate by containing these resins or precursors thereof. It is preferable that these resins or precursors thereof are similar to those to be mixed when the coating liquid for substrate formation is prepared. Moreover, the content of these resins or precursors thereof in the conductive agent dispersion B is not particularly limited but is preferably 10 parts by mass or more and 500 parts by mass or less, more preferably 25 parts by mass or more and 200 parts by mass or less, and still more preferably 50 parts by mass or more and 100 parts by mass or less with respect to 100 parts by mass of the conductive agent in the conductive agent dispersion B.

In addition, it is preferable that the conductive agent dispersion B further contains the surfactant in addition to the conductive agent and the dispersion medium. This is because the conductive agent can be more uniformly dispersed in the substrate by containing a surfactant. The content of surfactant in the conductive agent dispersion B is not particularly limited but is preferably 0.01 part by mass or more and 5 parts by mass or less, more preferably 0.25 part by mass or more and 2 parts by mass or less, and still more preferably 0.5 part by mass or more and 1 part by mass or less with respect to 100 parts by mass of the conductive agent in the conductive agent dispersion B.

Incidentally, other additives may be contained in the conductive agent dispersion B if necessary.

The application of coating liquid for substrate formation is preferably performed while rotating the cylindrical mold around the rotation axis. As an example, a method is mentioned in which a coating liquid for substrate formation is applied to the inner peripheral surface of a cylindrical mold through a dispenser and the mold is rotated to form a spread layer (coating layer) having a uniform thickness, or the like. The peripheral speed of the mold is not particularly limited but is preferably 10 rpm or more and 3,000 rpm or less, more preferably 100 rpm or more and 2,500 rpm or less, and still more preferably 1,000 rpm or more and 2,000 rpm or less. In addition, in a case in which the mold is rotated after application of the coating liquid, the rotation time of the mold is not particularly limited but is preferably 1 minute or more and 60 minutes or less, more preferably 5 minutes or more and 30 minutes or less, and still more preferably 10 minutes or more and 20 minutes or less.

Drying conditions of the coating film are not particularly limited, and known conditions can be used. Drying of the coating film may be performed through a plurality of stages.

The drying temperature varies depending on the composition of the coating liquid for substrate formation but is preferably 25° C. or more and 450° C. or less, and the temperature for drying by heating is preferably 50° C. or more and 450° C. or less in the case of performing drying by heating. Incidentally, drying by heating may be performed after drying at room temperature (25° C.). In a case in which drying by heating is performed through multiple stages, the temperature for the first drying by heating is preferably 50° C. or more and 150° C. or less. In addition, the temperature for the second drying by heating is preferably 150° C. or more and 450° C. or less and more preferably 150° C. or more and 400° C. or less. Moreover, the temperature for the third drying by heating is preferably 200° C. or more and 450° C. or less and more preferably 200° C. or more and 400° C. or less.

Incidentally, in a case in which the coating liquid for substrate formation contains a precursor of polyimide, polyamide-imide, or polyetherimide, the second and subsequent drying by heating can also serve as the thermal imidization treatment to be described later if the temperatures for the second and subsequent drying by heating are in the above ranges.

The time for drying by heating of the coating film varies depending on the composition of the coating liquid for substrate formation and is not particularly limited as long as the coating film can be sufficiently dried. Here, in a case in which drying by heating is performed through multiple stages, the time for drying by heating at the respective stages are all preferably 5 minutes or more and 180 minutes or less. In addition, the times for the first and second drying by heating are all more preferably 10 minutes or more and 90 minutes or less and still more preferably 10 minutes or more and 60 minutes or less. Moreover, in the drying by heating that also serves as the thermal imidization treatment, the time for drying by heating is more preferably 10 minutes or more and 180 minutes or less and still more preferably 30 minutes or more and 180 minutes or less.

The conditions in the case of performing the thermal imidization treatment are not particularly limited, and known conditions can be used. The temperature for thermal imidization varies depending on the composition of the substrate forming material including a precursor of polyimide, polyamide-imide, or polyetherimide (polyamide acid, polyamide-polyamide acid copolymer, or the like) as well but is preferably 150° C. or more and 450° C. or less.

The time for the thermal imidization treatment varies depending on the composition of the substrate forming material including a precursor of polyimide or polyamide-imide (polyamide acid, polyamide-polyamide acid copolymer, or the like) as well but is preferably 5 minutes or more and 180 minutes or less.

The drying and thermal imidization of coating film are preferably performed while rotating the cylindrical mold around the rotation axis. The peripheral speed of the cylindrical mold at the time of drying is not particularly limited but is preferably 1 rpm or more and 1,000 rpm or less, more preferably 5 rpm or more and 800 rpm or less, and still more preferably 10 rpm or more and 400 rpm or less.

(Formation of Other Layers)

The methods for forming other layers to be further provided in addition to the substrate if necessary are not particularly limited, and each layer can be formed by a known method. Examples of a method for forming an elastic layer include a method in which a film is formed using a coating liquid for elastic layer formation in which an elastic layer forming material containing an elastic material, a conductive agent, and other components that can be used if necessary is dissolved in a solvent, a method in which a coating film is formed by melting an elastic layer forming material containing an elastic material, a conductive agent, and other components that can be used if necessary, and the like. In addition, examples of a method for forming a surface layer include a method in which a coating film is formed by applying a coating liquid for surface layer formation containing a curable resin material and further a polymerization initiator and then cured.

<Image Forming Apparatus and Image Forming Method>

Another embodiment of the present invention relates to an image forming apparatus including the intermediate transfer belt described above. The image forming apparatus including the intermediate transfer belt described above is not particularly limited and can be used in a known image forming apparatus. Among these, the image forming apparatus is, for example, an electrophotographic image forming apparatus. The electrophotographic image forming apparatus is preferably used in an image forming apparatus equipped with a primary transfer means for performing primary transfer of an image (for example, a toner image or the like) electrostatically formed on an image carrier (photoconductor drum) to the intermediate transfer belt which circulates and moves and a secondary transfer means for performing secondary transfer of an image (for example, an intermediate toner image or the like) formed on the intermediate transfer belt to an image support.

In other words, the intermediate transfer belt described above is preferably used in an image forming method including performing primary transfer of an image to the intermediate transfer belt and performing secondary transfer of the image transferred to the intermediate transfer belt to an image support. Moreover, the image forming method is more preferably used in an image forming method including electrostatically forming an image on an image carrier, performing primary transfer of the image to the intermediate transfer belt which circulates and moves, and performing secondary transfer of an image formed on the intermediate transfer belt to an image support.

Hereinafter, the image forming apparatus and image forming method according to an embodiment of the present invention will be described with reference to the attached drawings. However, the present invention is not limited to only an embodiment to be described below.

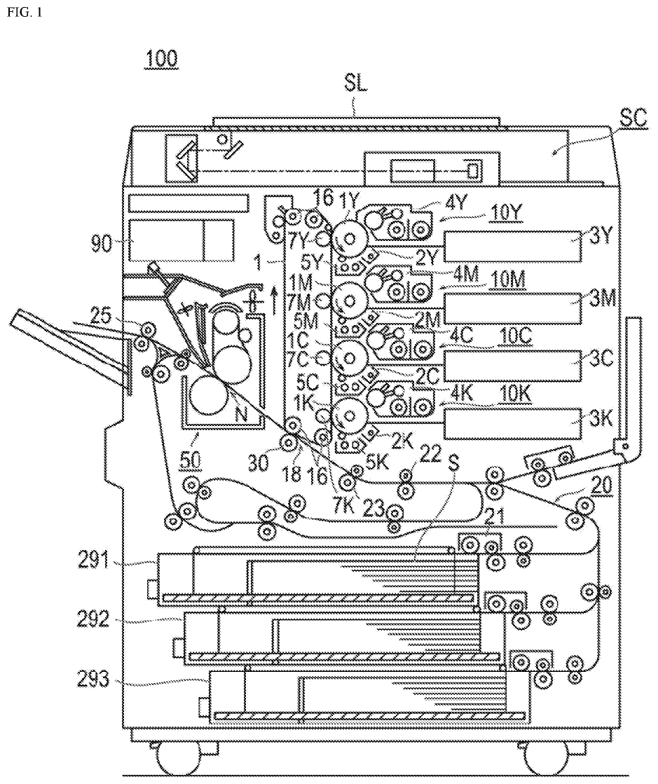

FIG. 1 is an explanatory sectional view illustrating an example of the configuration of an image forming apparatus including an intermediate transfer belt.

An image forming apparatus 100 forms a color image on a recording medium (for example, paper or the like) which is an image support using an electrophotographic image forming process.

This image forming apparatus 100 is also called a tandem-type color image forming apparatus and forms a color image by four sets of image forming units. The four image forming units are an image forming unit 10Y that forms a yellow (Y) color image, an image forming unit 10M that forms a magenta (M) color image, an image forming unit 10C that forms a cyan (C) color image, and an image forming unit 10K that forms a black (K) color image.

The image forming unit 10Y includes a photoconductor drum 1Y as an image carrier and a charging unit 2Y, an optical writing unit 3Y, a developing device 4Y, and a photoconductor drum cleaning device 5Y that are disposed in the vicinity of the photoconductor drum 1Y. Similarly, the image forming unit 10M includes a photoconductor drum 1M as an image carrier and a charging unit 2M, an optical writing unit 3M, a developing device 4M, and a photoconductor drum cleaning device 5M that are disposed in the vicinity of the photoconductor drum 1M. The image forming unit 10C includes a photoconductor drum 1C as an image carrier and a charging unit 2C, an optical writing unit 3C, a developing device 4C, and a photoconductor drum cleaning device 5C that are disposed in the vicinity of the photoconductor drum 1C. The image forming unit 10K includes a photoconductor drum 1K as an image carrier, and a charging unit 2K, an optical writing unit 3K, a developing device 4K, and a photoconductor drum cleaning device 5K that are disposed in the vicinity of the photoconductor drum 1K. Incidentally, the respective image forming units 10Y, 10M, 10C, and 10K have configurations in which the photoconductor drums 1Y, 1M, 1C, and 1K have the same function, the charging units 2Y, 2M, 2C, and 2K have the same function, the optical writing units 3Y, 3M, 3C, and 3K have the same function, the developing devices 4Y, 4M, 4C, and 4K have the same function, and the photoconductor drum cleaning devices 5Y, 5M, 5C, and 5K have the same function, respectively.

The intermediate transfer belt 1 is the intermediate transfer belt described above. The intermediate transfer belt 1 is erected by a plurality of support rollers 16 so as to run.

The toner images of the respective colors formed on the image forming units 10Y, 10M, 10C, and 10K are sequentially transferred onto the intermediate transfer belt 1 running by the primary transfer units 7Y, 7M, 7C, and 7K. A color image (toner image) in which the layers of the respective colors (Y, M, C, and K) are superimposed one upon another is thus primarily transferred onto the intermediate transfer belt 1.

A secondary transfer roller 30 is disposed in contact with the intermediate transfer belt 1. The secondary transfer roller 30 is driven in accordance with the movement of the intermediate transfer belt 1. One of the plurality of support rollers 16 is disposed at a position facing the secondary transfer roller 30 with the intermediate transfer belt 1 interposed therebetween. A secondary transfer nip portion 18 is formed by the secondary transfer roller 30 and the intermediate transfer belt 1.

A paper conveying unit 20 conveys paper S. The paper S is accommodated in paper feeding trays 291, 292, and 293 and is fed by a first paper feeding unit 21 and is conveyed to the secondary transfer nip portion 18 via a pair of loop forming rollers 22 and a pair of register rollers 23.

The color image formed on the intermediate transfer belt 1 is secondarily transferred onto the paper S at the secondary transfer nip portion 18. As heat and pressure are applied to the paper S to which the color image has been transferred at a nip portion N of a fixing device 50, the toner image on the paper S is fused and fixed. Moreover, the paper S is delivered out of the apparatus by a deliver roller 25.

The respective units of the image forming apparatus 100 are connected to a control unit 90 and are appropriately controlled by the control unit 90. A CPU (not illustrated) configured as a part of the control unit 90 executes a process of counting and integrating the number of pixels of the formed image or a process of counting and integrating the number of paper S subjected to the image forming process, and the like. The details of these processes will be described later. Incidentally, programs corresponding to these processes are stored in a storage unit (not illustrated) included in the control unit 90, and the like. Each function of each unit of the image forming apparatus 100 is exerted as the CPU executes a corresponding program.

Incidentally, the image forming apparatus 100 may include constituents other than the respective constituents described above, or some of the constituents described above may not be included in the image forming apparatus 100.

Next, an electrophotographic process of forming an image on paper by the image forming apparatus 100 will be described.

First, an original is placed on an original holder having a slit SL at the top, an image of the placed original is scanned and exposed by an optical system of a scanning exposure device of an image reading device SC, and light reflected from the original is read by a line image sensor via a mirror and is photoelectrically converted. The image information signals for every color generated by the photoelectric conversion are subjected to analog processing, A/D conversion, shading correction, image compression processing, and the like by an image processing unit (not illustrated) and then are input to the optical writing units 3Y, 3M, 3C, and 3K of the image forming units 10Y, 10M, 10C, and 10K for the corresponding colors, respectively.

The optical writing units 3Y, 3M, 3C, and 3K of the image forming units 10Y, 10M, 10C, and 10K write the image information signals on the photoconductor drums 1Y, 1M, 1C, and 1K to form latent images on the photoconductor drums 1Y, 1M, 1C, and 1K based on the image information signals. Specifically, the photoconductor drums 1Y, 1M, 1C, and 1K have a photosensitive layer formed of a resin such as polycarbonate and containing an organic photoconductor (OPC) on a metal substrate. The surfaces of the photoconductor drums 1Y, 1M, 1C, and 1K are charged with ions generated by charging units 2Y, 2M, 2C, and 2K composed of corona discharge electrodes of a scorotron type and the like, and the optical writing units 3Y, 3M, 3C, and 3K scan and expose the photoconductor drums 1Y, 1M, 1C, and 1K based on the image information signals. The potential of the exposed portions of the charged photoconductor drums 1Y, 1M, 1C, and 1K decreases, and electrostatic latent images corresponding to the image information signals are formed on the photoconductor drums 1Y, 1M, 1C, and 1K. The developing devices 4Y, 4M, 4C, and 4K develop the electrostatic latent images formed on the photoconductor drums 1Y, 1M, 1C, and 1K with toner by utilizing electrostatic force and form toner images corresponding to the respective colors.

Here, the toner for development is charged to the same polarity as that of the photoconductor drums 1Y, 1M, 1C, and 1K. For example, the photoconductor drums 1Y, 1M, 1C, and 1K are negatively charged. The negatively charged toner is attached only to the latent image portion of which the potential has been decreased by the optical writing units 3Y, 3M, 3C, and 3K among the regions on the negatively charged photoconductor drums 1Y, 1M, 1C, and 1K, and an electrostatic latent image can be formed on the photoconductor drums 1Y, 1M, 1C, and 1K. The electrostatic latent image on the photoconductor drums 1Y, 1M, 1C, and 1K are primarily transferred onto the intermediate transfer belt 1, and a toner image can be formed on the intermediate transfer belt 1. At this time, transfer of the negatively charged toner to the intermediate transfer belt 1 can be promoted by positively charging the intermediate transfer belt 1. Incidentally, a patch which is not transferred to the paper S is formed on the intermediate transfer belt 1 for correction and the like of the print density, color, or image forming position. The toner for forming the patch is negatively charged similarly to the toner for forming the electrostatic latent image. Thereafter, the toner image formed on the intermediate transfer belt 1 is secondarily transferred onto the paper S at the secondary transfer nip portion 18. At this time, transfer of the toner image positively charged by the intermediate transfer belt 1 to the paper S can be promoted by negatively charging the paper S.

By using the intermediate transfer belt described above in the image forming apparatus as described above, it is possible to realize both excellent image transferability and thin paper separating property.

### Examples

The effects of the present invention will be described with reference to the following Examples and Comparative Examples. In the following Examples, “parts” and “%” each mean “parts by mass” and “% by mass” unless otherwise stated. Incidentally, the present invention is not limited to the following Examples.

<Manufacture of Intermediate Transfer Belt>

### [Preparation of Surface-Treated Highly Dielectric Inorganic Particles]

According to the following procedure, surface-treated highly dielectric inorganic particles 1 to 7 were prepared, respectively.

(Surface-Treated Highly Dielectric Inorganic Particles 1)

An aqueous dispersion of barium titanate particles was obtained by mixing and stirring 100 parts by mass of barium titanate particles (BaTiO₃, specific gravity: 6.02 g/m³, relative dielectric constant εᵣ: 1,000, number average particle size (average primary particle size): 100 nm) which were highly dielectric inorganic particles and 400 parts by mass of water. Subsequently, an aqueous solution containing sodium aluminate (amphoteric metal-added liquid) in an amount equivalent to 5% by mass in terms of Al₂O₃ with respect to 100% by mass of the barium titanate particles was added to the aqueous dispersion, sulfuric acid (1N) was further added to the mixture dropwise so that the pH was maintained at about 7.5, and then the obtained dispersion was stirred and aged for 1 hour to subject the barium titanate particles to a surface treatment with hydrated alumina Subsequently, the obtained barium titanate particles having the surface treated with hydrated alumina were filtered, washed, and dried at 120° C. for 15 hours. Thereafter, the dried barium titanate particles having the surface treated with hydrated alumina were pulverized using an automatic mortar (ANM1000 manufactured by NITTO KAGAKU CO., LTD.), thereby obtaining surface-treated highly dielectric inorganic particles 1, which were barium titanate particles subjected to a surface treatment with alumina

(Surface-Treated Highly Dielectric Inorganic Particles 2)

A methanol dispersion of barium titanate particles was obtained by mixing and stirring 100 parts by mass of barium titanate particles (BaTiO₃, specific gravity: 6.02 g/m³, relative dielectric constant εᵣ: 1,000, number average particle size (average primary particle size): 300 nm) which were highly dielectric inorganic particles and 200 parts by mass of methanol. Moreover, a solution containing a coupling agent was obtained by mixing and stirring 160 parts by mass of methanol, 2 parts by mass of acetic acid, 0.2 part by mass of water, and 14 parts by mass of 3-aminopropyltrimethoxysilane (KBM-903 manufactured by Shin-Etsu Chemical Co., Ltd.) which was a coupling agent. Subsequently, the solution containing a coupling agent was added to the methanol dispersion of barium titanate particles, and the mixture was stirred at room temperature (25° C.) for 1 hour. Thereafter, the obtained dispersion was dried under reduced pressure to evaporate the solvent and heated at 120° C. for 2 hours. Thereafter, the dried barium titanate particles having the surface treated with 3-aminopropyltrimethoxysilane were crushed using an automatic mortar (ANM1000 manufactured by NITTO KAGAKU CO., LTD.), thereby obtaining surface-treated highly dielectric inorganic particles 2, which were barium titanate particles subjected to a surface treatment with a coupling agent.

(Surface-Treated Highly Dielectric Inorganic Particles 3)

After, 100 parts by mass of highly dielectric inorganic particles (BaTiO₃, specific gravity: 6.02 g/m³, relative dielectric constant εᵣ: 1,000, number average particle size (average primary particle size): 100 nm) were put in a Henschel mixer and stirred at a peripheral speed of the stirring blade of 35 msec for 10 minutes, then 4 parts by mass of 3-glycidoxypropyltriethoxysilane (KBE-403 manufactured by Shin-Etsu Chemical Co., Ltd.) which was a coupling agent was added thereto, and the mixture was mixed at a peripheral speed of the stirring blade of 35 msec for 30 minutes. The obtained mixture was taken out to a vat and then heated at 100° C. for 1 hour, thereby obtaining surface-treated highly dielectric inorganic particles 3, which were barium titanate particles subjected to a surface treatment with a coupling agent.

(Surface-Treated Highly Dielectric Inorganic Particles 4)

Surface-treated highly dielectric inorganic particles, which were barium titanate particles treated with alumina, were obtained in the same manner as in the preparation of the surface-treated highly dielectric inorganic particles 1. Subsequently, surface-treated highly dielectric inorganic particles 4, which were barium titanate particles subjected to a surface treatment with alumina and a coupling agent, were obtained in the same manner as in the preparation of the surface-treated highly dielectric inorganic particles 2 except that the untreated highly dielectric inorganic particles were replaced with the obtained surface-treated highly dielectric inorganic particles, which were barium titanate particles treated with alumina

(Surface-Treated Highly Dielectric Inorganic Particles 5)

Surface-treated highly dielectric inorganic particles, which were barium titanate particles treated with alumina, were obtained in the same manner as in the preparation of the surface-treated highly dielectric inorganic particles 1. Subsequently, surface-treated highly dielectric inorganic particles 5, which were barium titanate particles subjected to a surface treatment with alumina and a coupling agent, were obtained in the same manner as in the preparation of the surface-treated highly dielectric inorganic particles 3 except that the untreated highly dielectric inorganic particles were replaced with the obtained surface-treated highly dielectric inorganic particles, which were barium titanate particles treated with alumina and the coupling agent was replaced with 3-isocyanatopropyltriethoxysilane (KBE-9007N manufactured by Shin-Etsu Chemical Co., Ltd.).

(Surface-Treated Highly Dielectric Inorganic Particles 6)

Surface-treated highly dielectric inorganic particles 6, which were strontium titanate particles subjected to a surface treatment with alumina, were obtained in the same manner as in the preparation of the surface-treated highly dielectric inorganic particles 1 except that barium titanate particles were replaced with strontium titanate particles (SrTiO₃, specific gravity: 5.13 g/m³, relative dielectric constant εᵣ: 300, number average particle size: 300 nm).

(Surface-Treated Highly Dielectric Inorganic Particles 7)

Surface-treated highly dielectric inorganic particles, which were strontium titanate particles treated with alumina, were obtained in the same manner as in the preparation of the surface-treated highly dielectric inorganic particles 6. Subsequently, surface-treated highly dielectric inorganic particles 7, which were strontium titanate particles subjected to a surface treatment with alumina and a coupling agent, were obtained in the same manner as in the preparation of the surface-treated highly dielectric inorganic particles 3 except that the untreated highly dielectric inorganic particles were replaced with the obtained surface-treated highly dielectric inorganic particles, which were strontium titanate particles treated with alumina and the coupling agent was replaced with 3-isocyanatopropyltriethoxysilane (KBE-9007N manufactured by Shin-Etsu Chemical Co., Ltd.).

### [Preparation of Highly Dielectric Inorganic Particle Dispersions A1 to A9]

Highly dielectric inorganic particle dispersions A1 to A9 were obtained by mixing 30 parts by mass of each of the surface-treated highly dielectric inorganic particles 1 to 7 obtained above, untreated strontium titanate particles (SrTiO₃, specific gravity: 5.13 g/m³, relative dielectric constant εᵣ 300, number average particle size (average primary particle size): 300 nm), and untreated barium titanate particles (BaTiO₃, specific gravity: 6.02 g/m³, relative dielectric constant εᵣ: 1,000, number average particle size (average primary particle size): 100 nm) with 70 parts by mass of N-methyl-2-pyrrolidone (NMP) which was a dispersion medium and subjecting the mixtures to a dispersion treatment by ultrasonic waves.

Here, the dispersions containing the surface-treated highly dielectric inorganic particles 1 to 7 are referred to as (surface-treated) highly dielectric inorganic particle dispersions A1 to A7, respectively, the dispersion containing untreated strontium titanate particles is referred to as (untreated) highly dielectric inorganic particle dispersion A8, and the dispersion containing untreated barium titanate particles is referred to as (untreated) highly dielectric inorganic particle dispersion A9.

### [Preparation of Conductive Agent Dispersion B]

A solution was prepared by mixing and stirring 50 parts by mass of polyimide precursor (UPIA (registered trademark)—ST1001 (solid content: 18% by mass) manufactured by UBE INDUSTRIES, LTD.), 0.1 part by mass of a fluorine-containing organic compound which was a fluorine-based surfactant (F-Top (registered trademark) EF-351 manufactured by Mitsubishi Materials Corporation), and 50 parts by mass of N-methyl-2-pyrrolidone (NMP). Subsequently, 13 parts by mass of carbon black (NIPex (registered trademark) 150 (pH=4, volatile matter content: 10% by mass) manufactured by Evonik Japan Co., Ltd.) which was a conductive agent was added to the obtained solution, and the mixture was dispersed using a ball mill, thereby preparing a conductive agent dispersion B.

### [Manufacture of Intermediate Transfer Belts 1 to 9]

(Intermediate Transfer Belt 1)

A coating liquid for substrate formation was obtained by mixing 100 parts by mass of polyimide precursor varnish (UPIA (registered trademark)—ST1001 (solid content: 18% by mass) manufactured by UBE INDUSTRIES, LTD.), 65 parts by mass of the highly dielectric inorganic particle dispersion A1 obtained above, 15 parts by mass of the conductive agent dispersion B obtained above, and 20 parts by mass of N-methyl-2-pyrrolidone (NMP). Subsequently, the coating liquid was defoamed and then applied to the inner peripheral surface of a cylindrical mold in a state of being rotated at 1,500 rpm through a dispenser so that the thickness after drying was 60 μm, and then the mold was rotated for 15 minutes, thereby forming a spread layer (coating layer) having a uniform thickness. Subsequently, hot air at 60° C. was applied to the mold from the outside of the mold for 30 minutes while rotating the mold at 250 rpm, and then the mold was heated at 150° C. for 60 minutes. Thereafter, the mold was heated up to 360° C. at a rate of 2° C./min and further heated at 360° C. for 60 minutes. By such blowing of hot air and heating, the evaporated solvent and water generated by the dehydration and cyclization were removed from the spread layer and the imidization reaction in the spread layer was completed. An endless belt-like intermediate transfer belt 1 containing a polyimide resin and the surface-treated highly dielectric inorganic particles 1 was obtained in this manner.

(Intermediate Transfer Belts 2 to 9)

Intermediate transfer belts 2 to 9 were manufactured in the same manner in the manufacture of the intermediate transfer belt 1 except that the highly dielectric inorganic particle dispersion A1 was replaced with the highly dielectric inorganic particle dispersions A2 to A9, respectively.

The raw materials for the respective intermediate transfer belts are presented in the following Tables 1-1 and 1-2.

<Evaluation of Intermediate Transfer Belt>

### [Analysis of Particles in Intermediate Transfer Belt]

The obtained intermediate transfer belts 1 to 9 were cut in the thickness direction of the belt using a general-purpose section cutter for scanning electron microscope (SEM) sample preparation, the cross section was observed under a scanning electron microscope (SEM), the highly dielectric inorganic fine particles were identified, and elemental analysis was performed by EDS (energy dispersive X-ray spectroscopy). As a result of the elemental analysis, the following facts were confirmed.

It has been confirmed that alumina is present on the surfaces of the surface-treated highly dielectric inorganic particles 1 and 4 to 7 subjected to the alumina surface treatment and a silane coupling agent is present on the surfaces of the surface-treated highly dielectric inorganic particles 2 to 5 and 7 subjected to the coupling agent surface treatment.

Moreover, it has been confirmed that the surface-treated highly dielectric inorganic particles 2, 4, 5, and 7 have a nitrogen atom on the surface thereof and the surface-treated highly dielectric inorganic particles 2 and 4 had an amino group on the surfaces thereof.

### [Transferability]

Using an evaluation machine fabricated by attaching the intermediate transfer belt manufactured above to an image forming apparatus (bizhub (registered trademark) PRESS C1100 manufactured by Konica Minolta, Inc.), 100% solid images of blue which was a secondary color of cyan and magenta were each output on 10 sheets of embossed paper (LEATHAC PAPER A3 Y 302 g/m² manufactured by Tokushu Tokai Paper Co., Ltd.). Subsequently, the obtained individual solid images were digitized by a scanner into digital information, and the average values of the image densities of the individual solid images were determined by image processing using image editing and processing software (Photoshop (registered trademark) developed by Adobe Inc.). Subsequently, the area percentages (%) of regions having an image density of 90% or less of the average value in these individual solid images were determined, respectively. Moreover, the average value (%) of the area percentages of the regions having an image density of 90% or less of the above average value was further determined by calculating the sum of the area percentages of the regions having an image density of 90% or less of the average value in these individual solid images and dividing the sum by the total number of individual solid images. This value was taken as the area percentage (%) of region with 90% or less image density and evaluated according to the following evaluation criteria. Here, it has been judged that the result is favorable if the area percentage of region with 90% or less image density is less than 8%. The evaluation results on the transferability when the respective intermediate transfer belts were used are presented in the following Tables 1-1 and 1-2;

<<Evaluation Criteria>>

A: The area percentage of region with 90% or less image density is less than 2%,

B: The area percentage of region with 90% or less image density is 2% or more and less than 5%,

C: The area percentage of region with 90% or less image density is 5% or more and less than 8%, and

D: The area percentage of region with 90% or less image density is 8% or more.

### [Thin Paper Separating Property]

Using an evaluation machine fabricated by attaching the intermediate transfer belt manufactured above to an image forming apparatus (bizhub (registered trademark) PRESS C1100 manufactured by Konica Minolta, Inc.) and removing the separation claw of the intermediate transfer unit, a white solid image (white paper) was continuously printed on high-quality paper (SHIRAOI A3 Y 52.3 g/m² manufactured by NIPPON PAPER INDUSTRIES CO., LTD.) in an environment at a temperature of 10° C. and a relative humidity of 20% RH in a state in which the set current value of the secondary transfer was set to −200 μA. Thereafter, the intermediate transfer belt, which did not cause separation failure when printing was continuously performed by 1,000 sheets, was judged to be accepted and the intermediate transfer belt, which caused separation failure when printing was continuously performed by 1,000 sheets, was judged to be rejected. In a case in which separation failure occurs and the paper cannot be separated from the intermediate transfer belt, the paper moves as the intermediate transfer belt is driven, and is entangled with a member disposed in the vicinity of the intermediate transfer belt to cause the apparatus to stop. Incidentally, in the evaluation, as all of the image forming apparatus, the evaluation paper, and the intermediate transfer belt, those stored in an environment at a temperature of 10° C. and a relative humidity of 20% RH from the day before were used. The evaluation results on the peeling and separating properties when the respective intermediate transfer belts were used are presented in the following Tables 1-1 and 1-2.

TABLE 1
Raw materials and evaluation results of respective intermediate transfer belts

| Intermediate transfer belt | | | 1 | 2 | 3 | 4 | 5 |
|---|---|---|---|---|---|---|---|
| Resin | | | Polyimide | Polyimide | Polyimide | Polyimide | Polyimide |
| Surface- | Kind | | Surface- | Surface- | Surface- | Surface- | Surface- |
| treated or | | | treated | treated | treated | treated | treated |
| untreated | | | highly | highly | highly | highly | highly |
| highly | | | dielectric | dielectric | dielectric | dielectric | dielectric |
| dielectric | | | inorganic | inorganic | inorganic | inorganic | inorganic |
| inorganic | | | particles 1 | particles 2 | particles 3 | particles 4 | particles 5 |
| particles | | | | | | | |
| | Highly | Kind | BaTiO₃ | BaTiO₃ | BaTiO₃ | BaTiO₃ | BaTiO₃ |
| | dielectric | | particles | particles | particles | particles | particles |
| | inorganic | Number average | 100 | 300 | 100 | 100 | 100 |
| | particles | particle size (nm) | | | | | |
| | Alumina | Present or absent | Present | Absent | Absent | Present | Present |
| | surface | | | | | | |
| | treatment | | | | | | |
| | Coupling | Present or absent | Absent | Present | Present | Present | Present |
| | agent | | | | | | |
| | surface | | | | | | |
| | treatment | Kind | | 3-Aminopropyl- | 3-Glycidoxypropyl- | 3-Aminopropyl- | 3-Isocyanatopropyl- |
| | | | | trimethoxy- | triethoxy- | trimethoxy- | triethoxy- |
| | | | | silane | silane | silane | silane |

| | | | | | | |
|---|---|---|---|---|---|---|
| Evaluation | Transfer rate (%) | B | B | B | A | A |
| results | Thin paper separating property | Accepted | Accepted | Accepted | Accepted | Accepted |

| | | | | | |
|---|---|---|---|---|---|
| Remarks | Present | Present | Present | Present | Present |
| | invention | invention | invention | invention | invention |

| Intermediate transfer belt | | | 6 | 7 | 8 | 9 |
|---|---|---|---|---|---|---|
| Resin | | | Polyimide | Polyimide | Polyimide | Polyimide |
| Surface- | Kind | | Surface- | Surface- | Untreated | Untreated |
| treated | | | treated | treated | SrTiO₃ | BaTiO₃ |
| or untreated | | | highly | highly | particles | particles |
| highly | | | dielectric | dielectric | | |
| dielectric | | | inorganic | inorganic | | |
| inorganic | | | particles 6 | particles 7 | | |
| particles | | | | | | |
| | Highly | Kind | SrTiO₃ | SrTiO₃ | SrTiO₃ | BaTiO₃ |
| | dielectric | | particles | particles | particles | particles |
| | inorganic | Number average | 300 | 300 | 300 | 100 |
| | particles | particle size (nm) | | | | |
| | Alumina | Present or absent | Present | Present | Absent | Absent |
| | surface | | | | | |
| | treatment | | | | | |
| | Coupling | Present or absent | Absent | Present | Absent | Absent |
| | agent | | | | | |
| | surface | | | | | |
| | treatment | Kind | | 3-Isocyanatopropyl- | | |
| | | | | triethoxy- | | |
| | | | | silane | | |

| | | | | | |
|---|---|---|---|---|---|
| Evaluation | Transfer rate (%) | B | B | C | B |
| results | Thin paper separating property | Accepted | Accepted | Rejected | Rejected |

| | | | | |
|---|---|---|---|---|
| Remarks | Present | Present | Comparative | Comparative |
| | invention | invention | Example | Example |

From the results presented in Tables 1-1 and 1-2 above, it has been confirmed that the intermediate transfer belts according to the present invention have a high transfer rate and excellent thin paper separating property. On the other hand, it has been confirmed that the intermediate transfer belts according to Comparative Examples are inferior in the thin paper separating property and the transfer rate is also insufficient in some cases.

While embodiments of the present invention have been described in detail, it should be understood that this is illustrative and exemplary, and not limiting, and the scope of the present invention should be interpreted by the appended claims.

### EXPLANATIONS OF LETTERS OR NUMERALS

1 Intermediate transfer belt
1Y, 1M, 1C, 1K Photoconductor drum
2Y, 2M, 2C, 2K Charging unit
3Y, 3M, 3C, 3K Optical writing unit
4Y, 4M, 4C, 4K Developing device
5Y, 5M, 5C, 5K Cleaning device
7Y, 7M, 7C, 7K Primary transfer unit
10Y, 10M, 10C, 10K Image forming unit
16 Supporting roller
18 Secondary transfer nip portion
20 Paper conveying unit
21 Primary paper feeding unit
22 Loop forming roller pair
23 Register roller pair
25 Paper delivery roller
291, 292, 293 Paper feeding tray
30 Secondary transfer roller
50 Fixing device
90 Control unit
100 Image forming apparatus
N Nip portion
S Paper
SC Image reading device
SL Slit

What is claimed is:

1. An intermediate transfer belt comprising a substrate, wherein
the substrate contains at least one resin selected from the group consisting of polyimide, polyimide-imide, and polyetherimide, and
highly dielectric inorganic particles subjected to at least one surface treatment selected from the group consisting of a surface treatment with an oxide of at least one metal selected from the group consisting of aluminum, zinc, tin, lead, silicon, zirconium, and titanium and a surface treatment with a coupling agent.

2. The intermediate transfer belt according to claim 1, wherein a relative dielectric constant εᵣ of the highly dielectric inorganic particles is 100 or more.

3. The intermediate transfer belt according to claim 1, wherein the highly dielectric inorganic particles subjected to at least one surface treatment contain a nitrogen element on a surface.

4. The intermediate transfer belt according to claim 1, wherein the highly dielectric inorganic particles subjected to at least one surface treatment contain an amino group on a surface.

5. The intermediate transfer belt according to claim 1, wherein the highly dielectric inorganic particles subjected to at least one surface treatment contain alumina on a surface.

6. The intermediate transfer belt according to claim 1, further comprising a conductive agent containing a carbon element.

7. The intermediate transfer belt according to claim 1, wherein the highly dielectric inorganic particles are barium titanate.

8. An image forming method, comprising: performing primary transfer of an image to the intermediate transfer belt according to claim 1; and performing secondary transfer of the image transferred to the intermediate transfer belt to an image support.

9. An image forming apparatus comprising the intermediate transfer belt according to claim 1.
